(19) United States
(12) Patent Application Publication
(10) Pub. No.: US 2025/0024248 A1
(43) Pub. Date: Jan. 16, 2025

(54) METHODS, DEVICES, AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/712,115

(22) PCT Filed: Nov. 22, 2021
(86) PCT No.: PCT/CN2021/132143

§ 371 Date: May 21, 2024

(51) Int. Cl. H04W 8/24; H04L 1/00; H04L 5/00

(52) U.S. Cl. CPC H04W 8/24; H04L 1/0003; H04L 5/0051

(57) ABSTRACT

Embodiments of the present disclosure relate to methods, devices, and computer readable medium for communication. According to embodiments of the present disclosure, a terminal device transmits capability information to a network device. The capability information indicates at least one MCS supported by the terminal device and at least one configuration associated with the at least one MCS. The at least one configuration comprises a set of parameters associated with the at least one MCS. The terminal device receives a configuration of a configured MCS from the network device. The configured MCS is not higher than the at least one MCS supported by the terminal device. In this way, it enables the terminal device assisting the scheduling, thereby improving spectral efficiency of the communication system.

### TECHNICAL FIELD

Embodiments of the present disclosure generally relate to the field of telecommunication, and in particular, to methods, devices, and computer readable medium for communication.

### BACKGROUND

In order to improve communication quality and capacity, several technologies have been proposed. For example, a digital modulation method needs to be applied to a signal before transmitting the signal. In telecommunications, a carrier wave, carrier signal, or just carrier, is a waveform that is modulate with an information-bearing signal for the purpose of conveying information. This carrier wave usually has a much higher frequency than the input signal does. MCS (Modulation and Coding Scheme) defines how many useful bits can be transmitted per Resource Element (RE). MCS depends on radio link quality. The better quality the higher MCS and the more useful data can be transmitted.

### SUMMARY

In general, example embodiments of the present disclosure provide a solution for communication.

In a first aspect, there is provided a method for communication. The communication method comprises: transmitting, at a terminal device and to a network device, capability information indicating: at least one modulation and coding scheme (MCS) supported by the terminal device and at least one configuration associated with the at least one MCS, wherein the at least one configuration comprises a set of parameters associated with the at least one MCS; and receiving, from the network device, a configuration of a configured MCS, wherein the configured MCS is not higher than the at least one MCS supported by the terminal device.

In a second aspect, there is provided a method for communication. The communication method comprises: receiving, at a network device and from a terminal device, capability information indicating: at least one modulation and coding scheme (MCS) supported by the terminal device and at least one configuration associated with the at least one MCS, wherein the at least one configuration comprises a set of parameters associated with the at least one MCS; and transmitting, to the terminal device, a configuration of a configured MCS, wherein the configured MCS is not higher than the at least one MCS supported by the terminal device.

In a third aspect, there is provided a terminal device. The terminal device comprises a processing unit; and a memory coupled to the processing unit and storing instructions thereon, the instructions, when executed by the processing unit, causing the terminal device to perform acts comprising: transmitting, to a network device, capability information indicating: at least one modulation and coding scheme (MCS) supported by the terminal device and at least one configuration associated with the at least one MCS, wherein the at least one configuration comprises a set of parameters associated with the at least one MCS; and receiving, from the network device, a configuration of a configured MCS, wherein the configured MCS is not higher than the at least one MCS supported by the terminal device.

In a fourth aspect, there is provided a network device. The network device comprises a processing unit; and a memory coupled to the processing unit and storing instructions thereon, the instructions, when executed by the processing unit, causing the network device to perform acts comprising: receiving, at a network device and from a terminal device, capability information indicating: at least one modulation and coding scheme (MCS) supported by the terminal device and at least one configuration associated with the at least one MCS, wherein the at least one configuration comprises a set of parameters associated with the at least one MCS; and transmitting, to the terminal device, a configuration of a configured MCS, wherein the configured MCS is not higher than the at least one MCS supported by the terminal device.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 is a flowchart of an example method in accordance with an embodiment of the present disclosure;

FIG. 4 is a flowchart of an example method in accordance with an embodiment of the present disclosure;

FIGS. 5A-5I show schematic diagrams of phase tracking reference signal (PTRS) patterns in accordance with an embodiment of the present disclosure, respectively;

FIG. 6 is a flowchart of an example method in accordance with an embodiment of the present disclosure;

FIG. 7 is a flowchart of an example method in accordance with an embodiment of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band above 71 GHz, frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, the modulation technology has been proposed. Phase noise is severer with increased carrier frequency. The term “phase noise” used herein can refer to the ratio of noise power at a given offset frequency to the power of the carrier frequency, denoted as dBc/Hz. It leads to a time-varied random phase fluctuations to the time-domain signal. The highest MCS supported by a terminal device can be decided by several parameters. The terminal device can report kinds of highest MCS/SE associated with different parameters. A network device can choose a best configuration according to a channel condition and the reported highest MCS/SE for the terminal device.

In the current new radio (NR) system, a frequency range from 52.6 GHz to 71 GHz is supported. Further, a carrier frequency higher than 71 GHz (for example, 71˜114 GHz) is introduced. Influenced by phase noise in high frequency, the demodulation capability of each terminal device is different with different conditions. It is worth studying on optimizing the configuration for the UE under different conditions. Moreover, it is also worth studying on avoiding the influences caused by phase noise in demodulation.

According to some conventional technologies, the terminal device may report a new capability of combination of subcarrier spacing (SCS), rank, and MCS, to assist the MCS configuration by the network device for different scenarios. In addition, the MCSs for rank/SCS combinations can be supported. However, the parameters considered to limit the MCS configuration are insufficient to keep a low probability of configuring a MCS cannot be demodulated. Moreover, according to some other conventional technologies, for supporting NR between 52.6 GHz and 71 GHz with high subcarrier spacing values including 480 kHz and 960 kHz, UE assistance for SCS/BWP selection should be supported to take into account all the channel measurements and receiver impairments that are more prominent at higher frequency range. However, the delay introduced by SCS switching is too large.

In addition, some conventional technologies propose that different operation mode associates with different parameters sets. The operation mode includes at least one power efficient mode. However, it can decrease the power consumption but it cannot be used to address the influence introduced by phase noise.

According to embodiments, solutions on UE-assistant scheduling are proposed. According to embodiments of the present disclosure, a terminal device transmits capability information to a network device. The capability information indicates at least one MCS supported by the terminal device and at least one configuration associated with the at least one MCS. The at least one configuration comprises a set of parameters associated with the at least one MCS. The terminal device receives a configuration of a configured MCS from the network device. The configured MCS is not higher than the at least one MCS supported by the terminal device. In this way, it enables the terminal device assisting the scheduling, thereby improving spectral efficiency of the communication system.

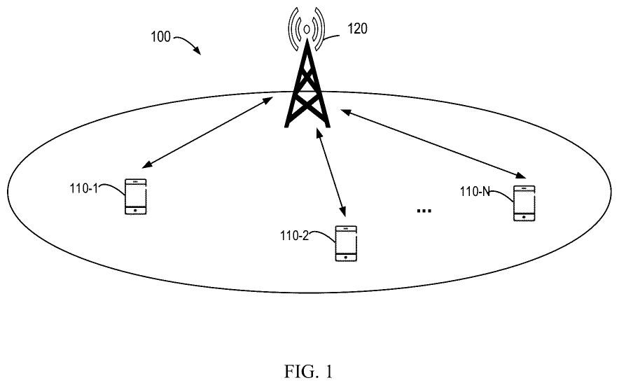

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The slot used herein may refer to a normal slot which comprises a predetermined number of symbols and also refer to a sub-slot which comprises fewer symbols than the predetermined number of symbols.

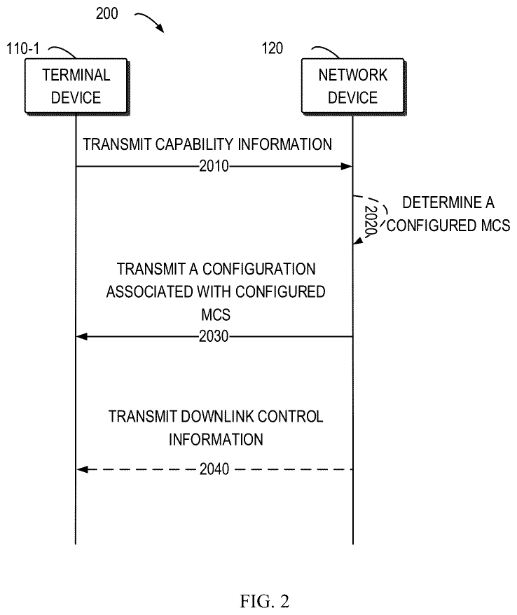

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1.

The terminal device 110-1 transmits 2010 capability information to the network device 120. The capability information indicates at least one MCS supported by the terminal device 110-1. For example, the capability information may indicate one or more maximum MCS which can be supported by the terminal device 110-1. The capability information also indicates at least one configuration associated with the MCS. The at least one configuration comprises a set of parameters associated with the at least one MCS. The term “capability information” used herein can refer to information associated with the MCS supported by the terminal device 110-1. The capability information can be transmitted via any proper signaling, for example, radio resource control (RRC) signaling. In some embodiments, the capability information can be a capability table. Only for the purpose of illustrations, embodiments of the present disclosure are described with the reference to the capability table. It should be noted that the capability information may be in any proper format.

In some embodiments, the set of parameters can comprise a carrier frequency. Additionally, the set of parameters may comprise a SCS. The set of parameters can also comprise a waveform. Alternatively or in addition, the set of parameters further comprise a PTRS pattern. The term “phase tracking reference signal (PTRS)” used herein can refer to a signal which is intended for phase-noise compensation. In some embodiments, different PTRS patterns may correspond to different MCS intervals. In addition, a higher SCS can correspond to a higher MCS. In other embodiments, a higher carrier frequency may correspond to a lower MCS. In some embodiments, a larger rank can correspond to a lower MCS.

In some embodiments, the capability table can comprise an index of the at least one MCS. Table 1 below shows an example of the capability table. It should be noted that values shown in Table 1 are examples not limitations. FR2-3 can refer to the frequency range from 71 GHz to 114 GHz. FR2-1 can refer to the frequency range from 24.25 GHz to 52.6 GHz. FR2-2 can refer to the frequency range 52.6 GHz to 71 GHz. Details of PTRS patterns will be described later.

TABLE 1

| Carrier | | | | | Index of | Index of |
|---|---|---|---|---|---|---|
| Frequency | | Waveform | PTRS | | MCS for | MCS for |
| (CF) | SCS | (WF) | Pattern | Rank | 64QAM | 256QAM |
| Frequency | 120 kHz | Cyclic Prefix - | Release-15 | 1-6 | 28 | 24 |
| Range | | Orthogonal | | | | |
| FR2-1 | | Frequency | | | | |
| | | Division | | | | |
| | | Multiplexing | | | | |
| | | (CP-OFDM) | | | | |
| FR2-1 | 120 kHz | Discrete Fourier | Release-15 | 1 | 28 | 24 |
| | | Transform spread | | | | |
| | | Orthogonal | | | | |
| | | Frequency | | | | |
| | | Division | | | | |
| | | Multiplexing | | | | |
| | | (DFT-s-OFDM) | | | | |
| FR2-2 | 120 kHz | CP-OFDM | Release-15 | 1 | 27 | 20 |
| FR2-2 | 120 kHz | CP-OFDM | Release-15 | 2 | 21 | 14 |
| FR2-2 | 120 kHz | CP-OFDM | Block-based | 1 | 28 | 24 |
| FR2-2 | 120 kHz | CP-OFDM | Block-based | 2 | 28 | 24 |
| FR2-2 | 120 kHz | CP-OFDM | Release-15 | 1 | 26 | 19 |
| FR2-2 | 120 kHz | DFT-s-OFDM | Release-15 | 1 | 22 | 16 |
| FR2-2 | 120 kHz | DFT-s-OFDM | Larger Ng | 1 | 28 | 27 |
| FR2-2 | 480 kHz | . . . | | | | |
| . . . | . . . | . . . | | | | |
| FR2-3* | 120 kHz | . . . | | | | |

For example, in some embodiments, the configuration associated with the MCS with the index 28 may comprise any one of: a CF in FR2-1, a SCS being 120 kHz, a PTRS pattern being pattern defined in Release 15 of NR, and a rank from 1-6. In this case, as shown in Table 1, the capability table indicates that the index of maximum MCS supported by the terminal device 110-1 is 28 for 64QAM MCS table (as Table 5.1.3.1-1 defined in section 5.1.3.1 of TS 38.214). The capability table also indicates the configuration associated with the MCS with the index 28.

In other embodiments, the at least one MCS comprises a first MCS and a second MCS. In this case, the capability table may comprise a first index of the first MCS and an offset of a second index of the second MCS to the first index of the first MCS. In other words, a difference value can be used for the indication for at least one maximum supported MCS. For example, an MCS index can be selected as the reference index, and the corresponding configuration can be seen as the reference configuration. And for the other configuration, a difference value with the reference index of the corresponding MCS may be reported.

In other embodiments, for the reference index, a difference between the value and the maximum MCS value in the MCS table can still be used, where A=Amax1−Amax2, Amax1 is the maximum supported MCS corresponding to the reference configuration, Amax2 is the maximum MCS value in the MCS table. Table 2 below shows an example of the capability table, where A, C are the reference indexes for two carrier frequencies and MCS table of 64QAM, and B, D are the reference indexes for two carrier frequencies and MCS table of 256QAM. It should be noted that values and the reference configuration shown in Table 2 are examples not limitations.

TABLE 2

| Carrier | | | | | Index of | Index of |
|---|---|---|---|---|---|---|
| Frequency | | Waveform | | | MCS for | MCS for |
| (CF) | SCS | (WF) | PTRS Pattern | Rank | 64QAM | 256QAM |
| FR2-1 | 120 kHz | CP-OFDM | Rel-15 | 1-6 | A | B |
| FR2-1 | 120 kHz | DFT-s-OFDM | Rel-15 | 1 | A + Δa1 | B + Δb1 |
| FR2-2 | 120 kHz | CP-OFDM | Rel-15 | 1 | C | D |
| FR2-2 | 120 kHz | CP-OFDM | Rel-15 | 2 | C + Δc1 | D + Δd1 |
| FR2-2 | 120 kHz | CP-OFDM | Block-based | 1 | C + Δc2 | D + Δd2 |
| FR2-2 | 120 kHz | CP-OFDM | Block-based | 2 | C + Δc3 | D + Δd3 |
| FR2-2 | 120 kHz | DFT-s-OFDM | Rel-15 | 1 | C + Δc4 | D + Δd4 |
| FR2-2 | 120 kHz | DFT-s-OFDM | Larger Ng | 1 | C + Δc5 | D + Δd5 |
| FR2-2 | 480 kHz | . . . | | | | |
| . . . | . . . | . . . | | | | |
| FR2-3* | 120 kHz | | | | | |

For example, in some embodiments, the configuration associated with the MCS with the index A may comprise any one of a CF in FR2-1, a SCS being 120 kHz, a PTRS pattern being Release 15, and a rank from 1-6. In this case, as shown in Table 2, the capability table indicates that the index of MCS supported by the terminal device 110-1 is A for 64QAM MCS table (as Table 5.1.3.1-1 defined in section 5.1.3.1 of TS 38.214). The capability table also indicates the configuration associated with the MCS with the index A. The capability table indicates the offset Δa1 of an index of the MCS of the other configuration, to the index of the maximum supported MCS A associated with the reference configuration. In some embodiments, there may be one reference index for the whole capability table. Alternatively, the may be one reference index for each frequency range. For example, as shown in Table 2, the reference index for FR 2-1 is represented as A and the reference index for FR 2-2 is represented as C.

Alternatively, the capability table comprises a third index of the at least one configuration. In this case, a relationship between the third index and the at least one configuration can be predefined. In some other embodiments, the terminal device 110-1 may report the indexes of the MCS in a predefined order of the at least one configuration. In this way, overhead of the signaling can be saved. Table 3 below shows an example of the relationship between the indexes and the configurations. It should be noted that values shown in Table 3 are examples not limitations.

TABLE 3

| Configuration | | | | PTRS | |
|---|---|---|---|---|---|
| Index | CF | SCS | WF | Pattern | Rank |
| 0 | FR2-1 | 120 kHz | CP-OFDM | Rel-15 | 1-6 |
| 1 | FR2-1 | 120 kHz | DFT-s-OFDM | Rel-15 | 1 |
| 2 | FR2-2 | 120 kHz | CP-OFDM | Rel-15 | 1 |
| 3 | FR2-2 | 120 kHz | CP-OFDM | Rel-15 | 2 |
| 4 | FR2-2 | 120 kHz | CP-OFDM | Block-based | 1 |
| 5 | FR2-2 | 120 kHz | CP-OFDM | Block-based | 2 |
| 6 | FR2-2 | 120 kHz | DFT-s-OFDM | Rel-15 | 1 |
| 7 | FR2-2 | 120 kHz | DFT-s-OFDM | Larger Ng | 1 |
| 8 | FR2-2 | 480 kHz | . . . | | |
| . . . | . . . | . . . | | | |
| N | FR2-3* | 120 kHz | | | |

In some embodiments, the terminal device 110-1 may transmit the maximum supported MCS in the capability table according to the order of the configurations as defined in Table 3. If the corresponding configuration is out of the terminal device's ability, the terminal device 110-1 may report an invalid value, denoted as “IVAD”. For example, for 64QAM, the terminal device 110-1 may report a list including: MCS_0, MCS_1, MCS_2, MCS_3, MCS_4, MCS_5, . . . , MCS_N,IVAD,MCS_N+2, and MCS_i is corresponding to configuration I predefined in the table, wherein configuration i means the configuration with index i.

The terminal device 110-1 may determine a spectrum efficiency (SE) associated with the at least one MCS. In this case, in some embodiments, the capability table may comprise the spectrum efficiency. Alternatively, the terminal device 110-1 may determine a fourth index of the spectrum efficiency. In this case, the capability table can comprise the fourth index of the spectrum efficiency instead of comprising two columns of supported MCS indexes. In this way, overhead of the signaling can be further saved. With the reported SE, the corresponding supported MCS value can be found by comparing the reported SE with the SE defined in the MCS table. In some embodiments, the MCS associated with the largest SE which is less than the reported one can be chosen as the maximum supported MCS. The reported SE can be indicated by an index with a predefined mapping table. A simply quantization can be used as one of the mapping relationship. Alternatively, non-uniform quantization can be used. In some embodiments, quantization step in low SE range can be larger than that in high SE range. In some embodiments, the difference index can be used. For example, an index of the SE can be selected as a reference index and the capability table may indicate an offset of another index of another SE to the reference index. The minimize SE in the mapping relationship can be larger than a threshold denoted by SE^{th}. The MCS corresponding to the SE which is smaller than SE^{th} can be demodulated in all the cases. Table 4 below shows an example of the relationship between the indexes and the SE. It should be noted that values shown in Table 4 are examples not limitations.

TABLE 4

| Index | SE |
|---|---|
| 0 | 1.327 |
| 1 | 1.8 |
| 2 | 2.25 |
| 3 | 2.7 |
| 4 | 3.3 |
| 5 | 3.5 |
| 6 | 3.9 |
| 7 | 4.3 |
| . . . | . . . |
| 15 | 7.5 |

For example, the terminal device 110-1 may determine that the SE corresponding to the at least one MCS is 1.8. In this case, as shown in Table 4, if the SE corresponding to the at least one MCS is 1.8, the capability table may comprise value “1.8” for the SE. Alternatively, the capability table may comprise index of 1 to indicate that the value of the reported SE is 1.8.

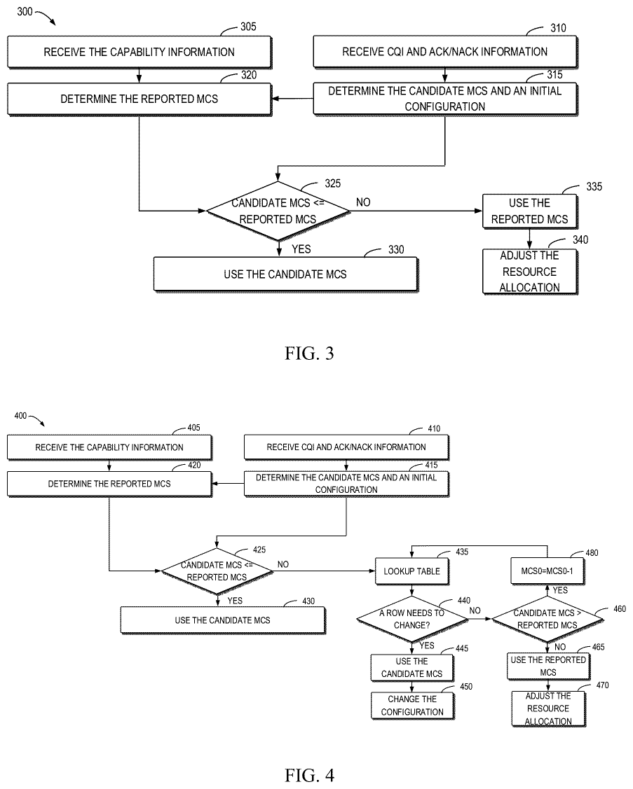

Referring back to FIG. 2, the network device 120 may determine 2020 a configured MCS based on the capability table. In this way, it ensures more flexible scheduling. Example embodiments for determining the configured MCS are described below with the reference to FIGS. 3 and 4. It should be noted that the methods shown in FIGS. 3 and 4 can also be applied to determination of rank value.

FIG. 3 shows an example method 300 for determining the configured MCS according to some embodiments of the present disclosure.

As shown in FIG. 3, at block 305, the network device 120 may receive the capability table from the terminal device 110-1. As mentioned above, the capability table can indicate one or more MCS (referred to as reported MCS).

At block 310, the network device 120 may receive channel quality information and/or ACK/NACK information from the terminal device 110-1. At block 315, the network device 120 may determine a candidate MCS and an initial configuration based on the channel quality information and/or ACK/NACK information. For example, the initial configuration may comprise an initial transmission rank. Alternatively or in addition, the initial configuration may comprise an initial PTRS pattern.

At block 320, the network device 120 may determine the reported MCS based on the capability table and the initial configuration. For example, the network device may look up the capability table which row indicates the configuration same as the initial configuration, and choose the related MCS index indicated by the capability table as the reported MCS for configured MCS determination.

At block 325, the network device 120 may determine whether the index of the candidate MCS is higher than the index of the reported MCS. At block 330, if the index of the candidate MCS is not higher than the index of the reported MCS, the network device 120 may use the candidate MCS as the configured MCS.

Alternatively, at block 335, if the index of the candidate MCS is higher than the index of the configured MCS, the network device 120 may use the reported MCS as the configured MCS. In some embodiments, at block 340, the network device 120 may adjust resource allocation based on the reported MCS and the candidate MCS, or based on the configured MCS and the candidate MCS. For example, if the configured MCS is lower than the candidate MCS, then more resource can be allocated to the terminal device.

FIG. 4 shows an example method 400 for determining the configured MCS according to some other embodiments of the present disclosure.

As shown in FIG. 4, at block 405, the network device 120 may receive the capability table from the terminal device 110-1. As mentioned above, the capability table can indicate one or more MCS (referred to as reported MCS).

At block 410, the network device 120 may receive channel quality information and/or ACK/NACK information from the terminal device 110-1. At block 415, the network device 120 may determine a candidate MCS and an initial configuration based on the channel quality information and/or ACK/NACK information. For example, the initial configuration may comprise an initial transmission rank. Alternatively or in addition, the initial configuration may comprise an initial PTRS pattern.

At block 420, the network device 120 may determine the reported MCS based on the capability table and the initial configuration. For example, the network device may look up the capability table which row indicates the configuration same as the initial configuration, and choose the related MCS index indicated by the capability table as the reported MCS for configured MCS determination.

At block 425, the network device 120 may determine whether the index of the candidate MCS is higher than the index of the reported MCS. At block 430, if the index of the candidate MCS is not higher than the index of the reported MCS, the network device 120 may use the candidate MCS as the configured MCS.

At block 435, if the index of the candidate MCS is higher than the index of the reported MCS, the network device 120 may find the rows whose reported MCS is equal to or higher than the candidate MCS. At block 440, the network device 120 may determine whether there is a row that only the configurations related to WF and/or PTRS type and/or rank is different from that of the initial configuration, in the rows found in block 435.

If such row in block 440 exists, the network device 120 may, at block 445, use the candidate MCS as the configured MCS. At block 450, the network device 120 may use the configuration according to the value of parameter in the row as the final configuration. For example, the parameters of Row i can be the original configuration, the corresponding reported MCS can be MCSᵢ. Row j can be the chosen row according to the procedure, the corresponding reported MCS can be MCSⱼ. Wherein MCSᵢ is lower than the candidate MCS, and MCSⱼ>=MCSᵢ, and MCSⱼ>=candidate MCS. The differences of the configurations between row i and row j may be: rank value, and/or waveform and/or the PTRS type.

Alternatively, if such row in block 440 does not exist, the network device 120 may, at block 460, determine whether the index of the candidate MCS is higher than the index of the reported MCS. At block 480, if the candidate MCS is higher than the index of the reported MCS, the network device 120 may reduce the index of the candidate MCS by one, and then the method proceed to block 435.

Alternatively, at block 465, if the index of the candidate MCS is not higher than the index of the reported MCS, the network device 120 may use the reported MCS as the configured MCS. In some embodiments, at block 470, the network device 120 may adjust resource allocation based on the reported MCS and the candidate MCS.

In this way, if only PTRS pattern is different between the initial configuration and the final configuration, the PTRS pattern can be indicated implicitly by the configured MCS, thereby saving signaling overhead. In other words, the terminal device 110-1 may determine the PTRS pattern based on the configured MCS and the at least one MCS supported by the terminal device. For example, the configuration only includes CF, SCS, WF, rank, and MCS. Based on the configuration of CF, SCS, WF, rank, several reported MCS values can be found in the capability table, each corresponding to a kind of PTRS pattern, where MCS1 corresponds to Release-15 pattern, MCS2 corresponds to block-based pattern. Then if the index of configured MCS is not higher than MCS1, the terminal device 110-1 may determine that the PTRS pattern is a Release-15 pattern. Alternatively, if the index of configured MCS is higher than MCS1, but not higher than MCS2, the terminal device 110-1 may determine that the PTRS pattern is a block-base pattern.

Now reference is made to FIG. 2. The network device 120 transmits 2030 a configuration associated with the configured MCS. For example, the configuration may indicate an index of the configured MCS. In some embodiments, the configuration may indicate a carrier frequency associated with the configured MCS. Alternatively or in addition, the configuration can indicate a waveform of the configured MCS. The configuration can be transmitted via RRC signaling. In some embodiments, before the transmission of the configured MCS, a configuration which comprises at least one of: a carrier frequency, SCS or WF can be transmitted via RRC signaling. Such configuration can be used to determine the configured MCS.

The network device 120 may transmit 2040 downlink control information to the terminal device 110-1. In some embodiments, the downlink control information may comprise a fifth index which indicates an antenna port with a rank not exceeding a predetermined value. For example, in some embodiments, due to the phase noise, rank value higher than 2 can't be demodulated. Alternatively, the supported MCS for higher rank value may be too low to increase SE. Therefore, the maximum rank value may be limited to 2 for frequency band above 71 GHz, and the related indicator in the downlink control information can be redesigned. In this case, the some index values for antenna ports indication may be reserved. Table 5 below shows an example of the relationship between the indexes and the antenna ports, where the demodulation reference signal (dmrs)-type is type-I and the maximum length of the DMRS symbols is 1. For example, the index values 10˜15 for the antenna ports indication are reserved. It should be noted that values shown in Table 5 are examples not limitations.

TABLE 5

| | Number of DMRS CDM | |
|---|---|---|
| Value | group(s) without data | DMRS port(s) |
| 0 | 1 | 0 |
| 1 | 1 | 1 |
| 2 | 1 | 0.1 |
| 3 | 2 | 0 |
| 4 | 2 | 1 |
| 5 | 2 | 2 |
| 6 | 2 | 3 |
| 7 | 2 | 0.1 |
| 8 | 2 | 2.3 |
| 9 | 2 | 0.2 |
| 10-15 | Reserved | Reserved |

Table 6 below shows an example of the relationship between the indexes and the antenna ports, where the dmrs-type is type-I and the maximum length of DMRS symbols are 2. For example, the index values 24˜31 for the antenna ports indication are reserved. It should be noted that values shown in Table 6 are examples not limitations.

TABLE 6

| | Number of DMRS CDM | DMRS | Number of front-load |
|---|---|---|---|
| Value | group(s) without data | port(s) | symbols |
| 0 | 1 | 0 | 1 |
| 1 | 1 | 1 | 1 |
| 2 | 1 | 0.1 | 1 |
| 3 | 2 | 0 | 1 |
| 4 | 2 | 1 | 1 |
| 5 | 2 | 2 | 1 |
| 6 | 2 | 3 | 1 |
| 7 | 2 | 0.1 | 1 |
| 8 | 2 | 2.3 | 1 |
| 9 | 2 | 0.2 | 1 |
| 10 | 2 | 0 | 2 |
| 11 | 2 | 1 | 2 |
| 12 | 2 | 2 | 2 |
| 13 | 2 | 3 | 2 |
| 14 | 2 | 4 | 2 |
| 15 | 2 | 5 | 2 |
| 16 | 2 | 6 | 2 |
| 17 | 2 | 7 | 2 |
| 18 | 2 | 0.1 | 2 |
| 19 | 2 | 2.3 | 2 |
| 20 | 2 | 4.5 | 2 |
| 21 | 2 | 6.7 | 2 |
| 22 | 2 | 0.4 | 2 |
| 23 | 2 | 2.6 | 2 |
| 24~31 | Reserved | Reserved | Reserved |

Alternatively or in addition, the downlink control information may comprise an indication of a configured waveform associated with the configured MCS. For example, length of the indicator may be 1 bit. In this situation, if the indication is “0”, it may represent that the waveform is CP-OFDM. If the indication is “1”, it may represent that the waveform is DFT-s-OFDM. In some other embodiments, the downlink control information may comprise a sixth index which indicates an antenna port with a rank not exceeding a predetermined value, and a configured waveform. In other word, the waveform indication can be associated with the rank value. For example, the waveform can be switched only when the rank value is 1. The indication of the configured waveform can be jointly encoded with the antenna port indicator. Table 7 below shows an example of the relationship between the indexes and the waveforms, where the dmrs-type is type-I and the maximum length of the DMRS symbols is 1.

TABLE 7

| | Number of DMRS CDM | DMRS | |
|---|---|---|---|
| Value | group(s) without data | port(s) | WF |
| 0 | 1 | 0 | CP-OFDM |
| 1 | 1 | 1 | CP-OFDM |
| 2 | 1 | 0.1 | CP-OFDM |
| 3 | 2 | 0 | CP-OFDM |
| 4 | 2 | 1 | CP-OFDM |
| 5 | 2 | 2 | CP-OFDM |
| 6 | 2 | 3 | CP-OFDM |
| 7 | 2 | 0.1 | CP-OFDM |
| 8 | 2 | 2.3 | CP-OFDM |
| 9 | 2 | 0.2 | CP-OFDM |
| 10 | 1 | 0 | DFT-s-OFDM |
| 11 | 1 | 1 | DFT-s-OFDM |
| 12 | 2 | 0 | DFT-s-OFDM |
| 13 | 2 | 1 | DFT-s-OFDM |
| 14 | 2 | 2 | DFT-s-OFDM |
| 15 | 2 | 3 | DFT-s-OFDM |

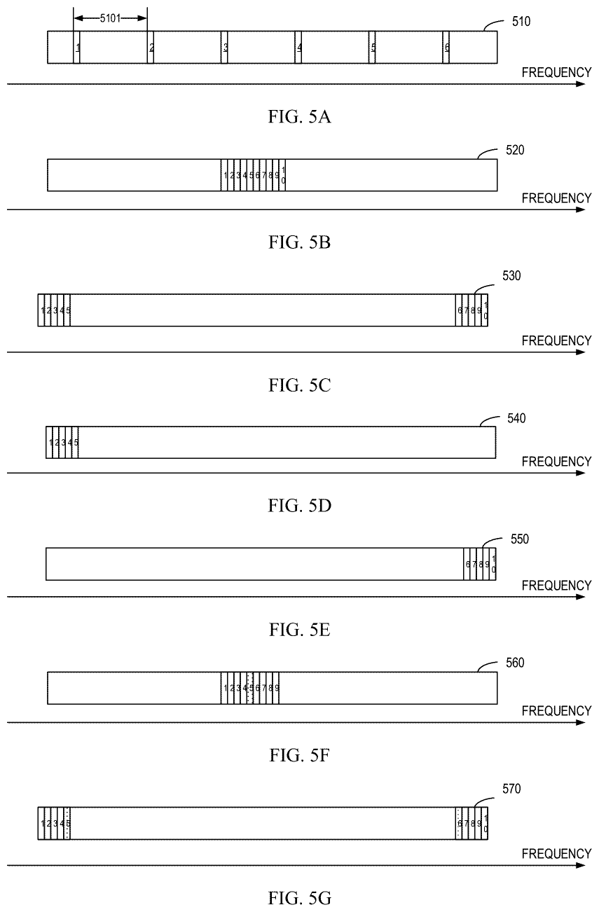

In some other embodiments, the downlink control information may indicate a configured PTRS pattern associated with the configured MCS, where the configured PTRS pattern includes the PTRS pattern type and the location in frequency domain of PTRS. For example, the downlink control information may comprise a set of bits to indicate the configured PTRS. Only as an example, the downlink control information may comprise 2 bits for indicating the configured PTRS. For example, the downlink control information may indicate that the configured PTRS pattern is Release-15 PTRS. In this case, the PTRS may be mapped evenly along the scheduled bandwidth based on a distributed pattern. In other words, the PTRS cannot be mapped to contiguous resource elements. For example, FIG. 5A shows the PTRS pattern 510 which refers to the Release-15 PTRS. As shown in FIG. 5A, the resource elements 1, 2, 3, 4, 5 and 6 can be used for transmitting the PTRS. The gap 5101 between the resource elements 1 and 2 (includes resource element 1) may comprise K*12 resource elements, wherein K is the frequency density of PTRS. It should be noted that the number of resource elements shown in FIG. 5A is only an example.

In some embodiments, the downlink control information may indicate that the configured PTRS pattern is PTRS pattern 1. In this case, the PTRS may be mapped at a middle part of a scheduled bandwidth based on a localized pattern or block-based pattern. The term “localized pattern” or “block-based pattern” used herein can refer to mapping over a several contiguous resource elements. In other words, the PTRS may be mapped to contiguous resource elements. For example, FIG. 5B shows the PTRS pattern 520 which refers to the PTRS pattern 1. As shown in FIG. 5B, the continuous resource elements 1, 2, 3, 4, 5, 6, 7, 8, 9 and 10 in the middle of the bandwidth can be used for transmitting the PTRS. It should be noted that the number of resource elements shown in FIG. 5B is only an example.

In other embodiments, the downlink control information may indicate that the configured PTRS pattern is PTRS pattern 2. In this case, the PTRS may be mapped at two edges of a scheduled bandwidth based on a localized pattern. In other words, the PTRS may be mapped to two groups of contiguous resource elements. For example, FIG. 5C shows the PTRS pattern 530 which refers to the PTRS pattern 2. As shown in FIG. 5C, the continuous resource elements 1, 2, 3, 4, 5 and the continuous resource elements 6, 7, 8, 9 and 10 at two edges of the bandwidth can be used for transmitting the PTRS. It should be noted that the number of resource elements shown in FIG. 5C is only an example.

In other embodiments, the downlink control information may indicate that the PTRS is not present.

In some embodiments, the downlink control information may indicate that the configured PTRS pattern is PTRS pattern 3. In this case the PTRS may be mapped at one edge of a scheduled bandwidth based on a localized pattern. In other words, the PTRS may be mapped to contiguous resource elements. For example, FIG. 5D shows the PTRS pattern 540 which refers to the PTRS pattern 3. As shown in FIG. 5D, the continuous resource elements 1, 2, 3, 4 and 5 at one edge of the bandwidth can be used for transmitting the PTRS. Alternatively, FIG. 5E shows the PTRS pattern 550 which refers to PTRS pattern 4 mapped at another edge of the scheduled bandwidth. As shown in FIG. 5E, the continuous resource elements 6, 7, 8, 9 and 10 at one edge of the bandwidth can be used for transmitting the PTRS. It should be noted that the numbers of resource elements shown in FIGS. 5D and 5E are only examples.

In other embodiments, the downlink control information may indicate that the PTRS is not present.

In some embodiments, the downlink control information may comprise two bits to indicate the configured PTRS pattern. Only as an example, “00” may represent the Release-15 PTRS pattern, “01” may represent the PTRS pattern 1, “10” may present the PTRS pattern 2, and “11” may indicate reserved or the PTRS is not present. It should be noted that the above bit values and the indication of each bit value are only examples not limitations.

Alternatively, the configured PTRS pattern further comprises: one non-zero power resource element and at least one zero power resource elements. In this case, the downlink control information may comprise more bits to indicate more types of the PTRS patterns. For example, an additional bit can be used to indicate whether the configured PTRS pattern is with zero power (ZP) tone.

In some embodiments, the non-zero power resource element may locate at middle of a block for the PTRS. For example, as shown in the PTRS pattern 560 in FIG. 5F, the continuous resource elements 1, 2, 3, 4, 5, 6, 7, 8 and 9 in the middle of the bandwidth can be allocated for the PTRS. The non-zero power resource element can be the resource element 5 which locates in the middle of the block.

Alternatively, the non-zero power resource element may locate at the edge of a block for the PTRS. For example, as shown in the PTRS pattern 570 in FIG. 5G, the continuous resource elements 1, 2, 3, 4, 5 and the continuous resource elements 6, 7, 8, 9 and 10 at two edges of the bandwidth can be allocated for the PTRS. In this case, the non-zero power resource elements can be the resource elements 5 and 6. Alternatively, as shown in the PTRS pattern 580 in FIG. 5H, the continuous resource elements 1, 2, 3, 4 and 5 at one edge of the bandwidth can be used for allocated for the PTRS and the non-zero power resource elements can be the resource element 5. In other embodiments, as shown in PTRS pattern 590 in FIG. 5I, the continuous resource elements 6, 7, 8, 9 and 10 at one edge of the bandwidth can be allocated for the PTRS and the non-zero power resource elements can be the resource element 6. It should be noted that the numbers of resource elements shown in FIGS. 5F to 5I are only examples. Locations of the non-zero power resource elements shown in FIGS. 5F to 5I are also examples.

In some embodiments, the network device 120 may transmit downlink transmission to the terminal device 110-1. In this case, if the terminal device 110-1 is unable to support the configured MCS, the terminal device 110-1 may skip a demodulation of the downlink transmission. The terminal device 110-1 may transmit a NACK to the network device 120 directly. In this situation, the time duration between a last symbol of the downlink transmission and a first symbol of a transmission of the NACK can be shorter than another time duration related to the demodulation of the downlink transmission. For example, the timeline related to NACK feedback does not have to meet the defined ones. Therefore, a new N1 for PDSCH processing timeline can be determined and a new PDSCH processing capability can be determined for the skipped PDSCH demodulation. The new timeline for the PDSCH processing capability can be far less than the conventional PDSCH processing capability. In this way, it can save time. In some embodiments, for example as shown in Table 8, the PDSCH processing capability may be same for all SCSs. In other embodiments, for example as shown in Table 9, the PDSCH processing capability may be different for different SCSs.

TABLE 8

| μ | PDSCH decoding time N₁ [symbols] |
|---|---|
| 3 | 4 |
| 5 | 4 |
| 6 | 4 |
| 7 | 4 |

TABLE 9

| μ | PDSCH decoding time N₁ [symbols] |
|---|---|
| 3 | 2 |
| 5 | 8 |
| 6 | 16 |
| 7 | 32 |

According to some embodiments of the present disclosure, the terminal device can report a table of the maximum supported MCS with different configuration parameters, and doesn't expect the configured MCS exceeds the reported one. The network device can receive the table and configure the MCS not exceeding the maximum one for a given set of parameters. In this way, it can ensure the UE to report a finer demodulation probability, then configuration of the invalid MCS can be avoided. According to some other embodiments of the present disclosure, the terminal device can determine the scheduling information of shared channels according to the configuration from the network device. For example, the PTRS pattern type information can be determined by the configured MCS. The network device can dynamically configure the MCS/PTRS pattern/rank/resource, make sure the configured MCS is no higher than the reported one. The PTRS pattern type information can be implicitly indicated by the configured MCS. In this way, a new configuration of PTRS type can be introduced and the detailed PTRS pattern is dynamically configured according to the scheduling scenarios, thereby ensuring a more flexible scheduling. Moreover, an implicitly indicating method can be used for the new PTRS pattern type, thereby saving the signaling overhead.

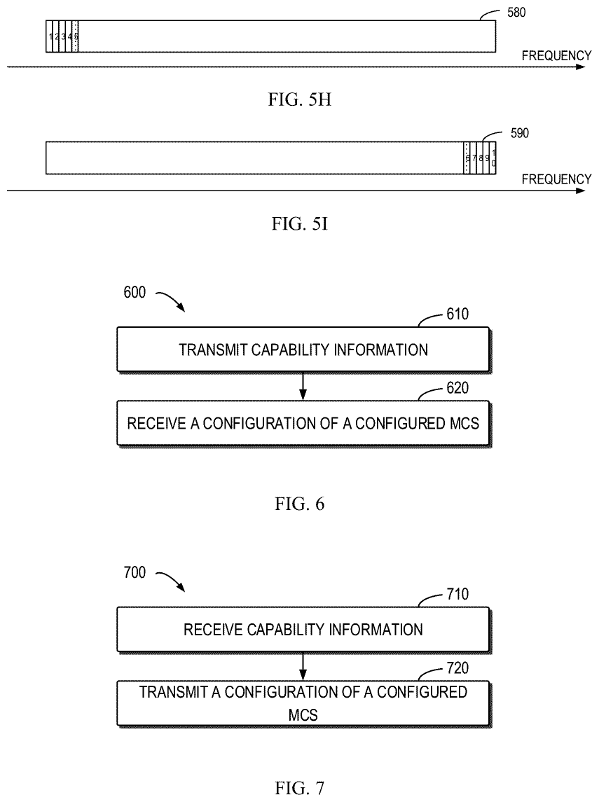

FIG. 6 shows a flowchart of an example method 600 in accordance with an embodiment of the present disclosure. The method 600 can be implemented at any suitable devices. Only for the purpose of illustrations, the method 600 can be implemented at a terminal device 110-1 as shown in FIG. 1.

At block 610, the terminal device 110-1 transmits capability information to the network device 120. The capability information indicates at least one MCS supported by the terminal device 110-1. For example, the capability information may indicate one or more maximum MCS which can be supported by the terminal device 110-1. The capability information also indicates at least one configuration associated with the MCS. The at least one configuration comprises a set of parameters associated with the at least one MCS. The term “capability information” used herein can refer to information associated with the MCS supported by the terminal device 110-1. The capability information can be transmitted via any proper signaling, for example, RRC signaling. In some embodiments, the capability information can be a capability table. Only for the purpose of illustrations, embodiments of the present disclosure are described with the reference to the capability table. It should be noted that the capability information may be in any proper format.

In some embodiments, the set of parameters can comprise a carrier frequency. Additionally, the set of parameters may comprise a SCS. The set of parameters can also comprise a waveform. Alternatively or in addition, the set of parameters further comprise a PTRS pattern. In some embodiments, different PTRS patterns may correspond to different MCS intervals. In addition, a higher SCS can correspond to a higher MCS. In other embodiments, a higher carrier frequency may correspond to a lower MCS. In some embodiments, a larger rank can correspond to a lower MCS.

In some embodiments, the capability table can comprise an index of the at least one MCS. In other embodiments, the at least one MCS comprises a first MCS and a second MCS. In this case, the capability table may comprise a first index of the first MCS and an offset of a second index of the second MCS to the first index of the first MCS. In other words, a difference value can be used for the indication for at least one maximum supported MCS. For example, an MCS index can be selected as the reference index, and the corresponding configuration can be seen as the reference configuration. And for the other configuration, a difference value with the reference index of the corresponding MCS may be reported. In other embodiments, for the reference index, a difference between the value and the maximum MCS value in the MCS table can still be used, where A=Amax1−Amax2, Amax1 is the maximum supported MCS corresponding to the reference configuration, Amax2 is the maximum MCS value in the MCS table. Alternatively, the capability table comprises a third index of the at least one configuration. In this case, a relationship between the third index and the at least one configuration can be predefined. In some other embodiments, the terminal device 110-1 may report the indexes of the MCS in a predefined order of the at least one configuration. In this way, overhead of the signaling can be saved.

The terminal device 110-1 may determine a SE associated with the at least one MCS. In this case, in some embodiments, the capability table may comprise the spectrum efficiency. Alternatively, the terminal device 110-1 may determine a fourth index of the spectrum efficiency. In this case, the capability table can comprise the fourth index of the spectrum efficiency instead of comprising two columns of supported MCS indexes. In this way, overhead of the signaling can be further saved. With the reported SE, the corresponding supported MCS value can be found by comparing the reported SE with the SE defined in the MCS table. In some embodiments, the MCS associated with the largest SE which is less than the reported one can be chosen as the maximum support MCS. The reported SE can be indicated by an index with a predefined mapping table. A simply quantization can be used as one of the mapping relationship. Alternatively, non-uniform quantization can be used. In some embodiments, quantization step in low SE range can be larger than that in high SE range. In some embodiments, the difference index can be used. For example, an index of the SE can be selected as a reference index and the capability table may indicate an offset of another index of another SE to the reference index. The minimize SE in the mapping relationship can be larger than a threshold denoted by SE^{th}. The MCS corresponding to the SE which is smaller than SE^{th} can be demodulated in all the cases.

At block 620, the terminal device 110-1 receives a configuration of a configured MCS from the network device 120. The configured MCS is not higher than the at least one MCS supported by the terminal device 110-1. In this way, it ensures more flexible scheduling. For example, the configuration may indicate an index of the configured MCS. In some embodiments, the configuration may indicate a carrier frequency associated with the configured MCS. Alternatively or in addition, the configuration can indicate a waveform of the configured MCS. The configuration can be transmitted via RRC signaling.

In some embodiments, before the reception of the configured MCS, a configuration which comprises at least one of: a carrier frequency, SCS or WF can be received from the network device 120 via RRC signaling. The terminal device 110-1 can determine the configured MCS based on such configuration.

In some embodiments, the terminal device 110-1 may receive downlink control information from the network device 120. In some embodiments, the downlink control information may comprise a fifth index which indicates an antenna port with a rank not exceeding a predetermined value. For example, in some embodiments, due to the phase noise, rank value higher than 2 can't be demodulated. Alternatively, the supported MCS for higher rank value may be too low to increase SE. Therefore, the maximum rank value may be limited to 2 for frequency band above 71 GHz, and the related indicator in the downlink control information can be redesigned. In this case, the some index values for antenna ports indication may be reserved.

Alternatively or in addition, the downlink control information may comprise an indication of a configured waveform associated with the configured MCS. For example, length of the indicator may be 1 bit. In this situation, if the indication is “0”, it may represent that the waveform is CP-OFDM. If the indication is “1”, it may represent that the waveform is DFT-s-OFDM. In some other embodiments, the downlink control information may comprise a sixth index which indicates an antenna port with a rank not exceeding a predetermined value, and a configured waveform. In other word, the waveform indication can be associated with the rank value. For example, the waveform can be switched only when the rank value is 1. The indication of the configured waveform can be jointly encoded with the antenna port indicator.

In some other embodiments, the downlink control information may indicate a configured PTRS pattern associated with the configured MCS, where the configured PTRS pattern includes the PTRS pattern type and the location in frequency domain of PTRS. For example, the downlink control information may comprise a set of bits to indicate the configured PTRS. Only as an example, the downlink control information may comprise 2 bits for indicating the configured PTRS. For example, the downlink control information may indicate that the configured PTRS pattern is Release-15 PTRS. In this case, the PTRS may be mapped evenly along the scheduled bandwidth based on a distributed pattern. In other words, the PTRS cannot be mapped to contiguous resource elements.

In some embodiments, the downlink control information may indicate that the configured PTRS pattern is PTRS pattern 1. In this case, the PTRS may be mapped at a middle part of a scheduled bandwidth based on a localized pattern or block-based pattern. The term “localized pattern” or “block-based pattern” used herein can refer to mapping over a several contiguous resource elements. In other words, the PTRS may be mapped to contiguous resource elements.

In other embodiments, the downlink control information may indicate that the configured PTRS pattern is PTRS pattern 2. In this case, the PTRS may be mapped at two edges of a scheduled bandwidth based on a localized pattern. In other words, the PTRS may be mapped to two groups of contiguous resource elements.

In some embodiments, the downlink control information may indicate that the configured PTRS pattern is PTRS pattern 3. In this case, the PTRS may be mapped at one edge of a scheduled bandwidth based on a localized pattern. In other words, the PTRS may be mapped to contiguous resource elements.

In some embodiments, the downlink control information may comprise two bits to indicate the configured PTRS pattern. Only as an example, “00” may represent the Release-15 PTRS pattern, “01” may represent the PTRS pattern 1, “10” may present the PTRS pattern 2, and “11” may indicate reserved or the PTRS is not present. It should be noted that the above bit values and the indication of each bit value are only examples not limitations.

Alternatively, the configured PTRS pattern further comprises: one non-zero power resource element and at least one zero power resource elements. In this case, the downlink control information may comprise more bits to indicate more types of the PTRS patterns. For example, an additional bit can be used to indicate whether the configured PTRS pattern is with zero power (ZP) tone.

In some embodiments, the non-zero power resource element may locate at middle of a block for the PTRS. Alternatively, the non-zero power resource element may locate at the edge of a block for the PTRS.

In some embodiments, the terminal device 110-1 may receive downlink transmission from the network device 120. In this case, if the terminal device 110-1 is unable to support the configured MCS, the terminal device 110-1 may skip a demodulation of the downlink transmission. The terminal device 110-1 may transmit a NACK to the network device 120 directly. In this situation, the time duration between a last symbol of the downlink transmission and a first symbol of a transmission of the NACK can be shorter than another time duration related to the demodulation of the downlink transmission. For example, the timeline related to NACK feedback does not have to meet the defined ones. Therefore, a new N1 for PDSCH processing timeline can be determined and a new PDSCH processing capability can be determined for the skipped PDSCH demodulation. The new timeline for the PDSCH processing capability can be far less than the conventional PDSCH processing capability. In this way, it can save time.

FIG. 7 shows a flowchart of an example method 700 in accordance with an embodiment of the present disclosure. The method 700 can be implemented at any suitable devices. Only for the purpose of illustrations, the method 700 can be implemented at a network device 120 as shown in FIG. 1.

At block 710, the network device 120 receives capability information from the terminal device 110-1. The capability information indicates at least one MCS supported by the terminal device 110-1. For example, the capability information may indicate one or more maximum MCS which can be supported by the terminal device 110-1. The capability information also indicates at least one configuration associated with the MCS. The at least one configuration comprises a set of parameters associated with the at least one MCS. The capability information can be transmitted via any proper signaling, for example, RRC signaling. In some embodiments, the capability information can be a capability table. Only for the purpose of illustrations, embodiments of the present disclosure are described with the reference to the capability table. It should be noted that the capability information may be in any proper format.

In some embodiments, the set of parameters can comprise a carrier frequency. Additionally, the set of parameters may comprise a SCS. The set of parameters can also comprise a waveform. Alternatively or in addition, the set of parameters further comprise a PTRS pattern. In some embodiments, different PTRS patterns may correspond to different MCS intervals. In addition, a higher SCS can correspond to a higher MCS. In other embodiments, a higher carrier frequency may correspond to a lower MCS. In some embodiments, a larger rank can correspond to a lower MCS.

In some embodiments, the capability table can comprise an index of the at least one MCS. In other embodiments, the at least one MCS comprises a first MCS and a second MCS. In this case, the capability table may comprise a first index of the first MCS and an offset of a second index of the second MCS to the first index of the first MCS. In other words, a difference value can be used for the indication for at lease one maximum supported MCS. For example, an MCS index can be selected as the reference index, and the corresponding configuration can be seen as the reference configuration. And for the other configuration, a difference value with the reference index of the corresponding MCS may be reported.

In some embodiments, for the reference index, a difference between the value and the maximum MCS value in the MCS table can still be used, where A=Amax1−Amax2, Amax1 is the maximum supported MCS corresponding to the reference configuration, Amax2 is the maximum MCS value in the MCS table.

Alternatively, the capability table comprises a third index of the at least one configuration. In this case, a relationship between the third index and the at least one configuration can be predefined. In some other embodiments, the terminal device 110-1 may report the indexes of the MCS in a predefined order of the at least one configuration. In this way, overhead of the signaling can be saved.

The terminal device 110-1 may determine a spectrum efficiency (SE) associated with the at least one MCS. In this case, in some embodiments, the capability table may comprise the spectrum efficiency. Alternatively, the terminal device 110-1 may determine a fourth index of the spectrum efficiency. In this case, the capability table can comprise the fourth index of the spectrum efficiency instead of comprising two columns of supported MCS indexes. In this way, overhead of the signaling can be further saved. With the reported SE, the corresponding supported MCS value can be found by comparing the reported SE with the SE defined in the MCS table. In some embodiments, the MCS associated with the largest SE which is less than the reported one can be chosen as the maximum supported MCS. The reported SE can be indicated by an index with a predefined mapping table. A simply quantization can be used as one of the mapping relationship. Alternatively, non-uniform quantization can be used. In some embodiments, quantization step in low SE range can be larger than that in high SE range. In some embodiments, the difference index can be used. For example, an index of the SE can be selected as a reference index and the capability table may indicate an offset of another index of another SE to the reference index. The minimize SE in the mapping relationship can be larger than a threshold denoted by SE^{th}. The MCS corresponding to the SE which is smaller than SE^{th} can be demodulated in all the cases.

In some embodiments, the network device 120 may determine a configured MCS based on the capability table. In this way, it ensures more flexible scheduling.

At block 720, the network device 120 transmits a configuration of the configured MCS. For example, the configuration may indicate an index of the configured MCS. In some embodiments, the configuration may indicate a carrier frequency associated with the configured MCS. Alternatively or in addition, the configuration can indicate a waveform of the configured MCS. The configuration can be transmitted via RRC signaling. In some embodiments, before the transmission of the configured MCS, a configuration which comprises at least one of a carrier frequency, SCS or WF can be transmitted via RRC signaling. Such configuration can be used to determine the configured MCS.

The network device 120 may transmit downlink control information to the terminal device 110-1. In some embodiments, the downlink control information may comprise a fifth index which indicates an antenna port with a rank not exceeding a predetermined value. For example, in some embodiments, due to the phase noise, rank value higher than 2 can't be demodulated. Alternatively, the supported MCS for higher rank value may be too low to increase SE. Therefore, the maximum rank value may be limited to 2 for frequency band above 71 GHz, and the related indicator in the downlink control information can be redesigned. In this case, the some index values for antenna ports indication may be reserved.

Alternatively or in addition, the downlink control information may comprise an indication of a configured waveform associated with the configured MCS. For example, length of the indicator may be 1 bit. In this situation, if the indication is “0”, it may represent that the waveform is CP-OFDM. If the indication is “1”, it may represent that the waveform is DFT-s-OFDM. In some other embodiments, the downlink control information may comprise a sixth index which indicates an antenna port with a rank not exceeding a predetermined value, and a configured waveform. In other word, the waveform can be associated with the rank value. For example, the waveform can be switched only when the rank value is 1. The indication of the configured waveform can be jointly encoded with the antenna port indicator.

In some other embodiments, the downlink control information may indicate a configured PTRS pattern associated with the configured MCS, where the configured PTRS pattern includes the PTRS pattern type and the location in frequency domain of PTRS. For example, the downlink control information may comprise a set of bits to indicate the configured PTRS. Only as an example, the downlink control information may comprise 2 bits for indicating the configured PTRS. For example, the downlink control information may indicate that the configured PTRS pattern is Release-15 PTRS. In this case, the PTRS may be mapped evenly along the scheduled bandwidth based on a distributed pattern. In other words, the PTRS cannot be mapped to contiguous resource elements.

In some embodiments, the downlink control information may indicate that the configured PTRS pattern is PTRS pattern 1. In this case, the PTRS may be mapped at a middle part of a scheduled bandwidth based on a localized pattern or block-based pattern. The term “localized pattern” or “block-based pattern” used herein can refer to mapping over a several contiguous resource elements. In other words, the PTRS may be mapped to contiguous resource elements.

In other embodiments, the downlink control information may indicate that the configured PTRS pattern is PTRS pattern 2. In this case, the PTRS may be mapped at two edges of a scheduled bandwidth based on a localized pattern. In other words, the PTRS may be mapped to two groups of contiguous resource elements.

In some embodiments, the downlink control information may indicate that the configured PTRS pattern is PTRS pattern 3. In this case, the PTRS may be mapped at one edge of a scheduled bandwidth based on a localized pattern. In other words, the PTRS may be mapped to contiguous resource elements.

In some embodiments, the downlink control information may comprise two bits to indicate the configured PTRS pattern. Only as an example, “00” may represent the Release-15 PTRS pattern, “01” may represent the PTRS pattern 1, “10” may present the PTRS pattern 2, and “11” may indicate reserved or the PTRS is not present. It should be noted that the above bit values are only examples not limitations.

Alternatively, the configured PTRS pattern further comprises: one non-zero power resource element and at least one zero power resource elements. In this case, the downlink control information may comprise more bits to indicate more types of the PTRS patterns. For example, an additional bit can be used to indicate whether the configured PTRS pattern is with zero power (ZP) tone.

In some embodiments, the non-zero power resource element may locate at middle of a block for the PTRS. Alternatively, the non-zero power resource element may locate at the edge of a block for the PTRS.

In some embodiments, the network device 120 may transmit downlink transmission to the terminal device 110-1. In this case, if the terminal device 110-1 is unable to support the configured MCS, the terminal device 110-1 may skip a demodulation of the downlink transmission. The terminal device 110-1 may transmit a NACK to the network device 120 directly. In this situation, the time duration between a last symbol of the downlink transmission and a first symbol of a transmission of the NACK can be shorter than another time duration related to the demodulation of the downlink transmission. For example, the timeline related to NACK feedback does not have to meet the defined ones. Therefore, a new N1 for PDSCH processing timeline can be determined and a new PDSCH processing capability can be determined for the skipped PDSCH demodulation. The new timeline for the PDSCH processing capability can be far less than the conventional PDSCH processing capability. In this way, it can save time.

In some embodiments, a terminal device comprises a circuitry configured to transmit to a network device, capability information indicating: at least one modulation and coding scheme (MCS) supported by the terminal device and at least one configuration associated with the at least one MCS, wherein the at least one configuration comprises a set of parameters associated with the at least one MCS; and receive, from the network device, a configuration of a configured MCS, wherein the configured MCS is not higher than the at least one MCS supported by the terminal device.

In some embodiments, the set of parameters at least comprises: a carrier frequency, a subcarrier spacing, and a waveform.

In some embodiments, the set of parameters further comprises at least one of: a phase tracking reference signal (PTRS) pattern for the at least one MCS, a rank of the at least one MCS, or a phase estimation algorithm.

In some embodiments, the capability information comprises an index of the at least one MCS.

In some embodiments, the at least one MCS comprises a first MCS and a second MCS, and the capability information comprises: a first index of the first MCS and an offset of a second index of the second MCS to the first index of the first MCS.

In some embodiments, the capability information comprises a third index of the at least one configuration, wherein a relationship between the third index and the at least one configuration is predefined.

In some embodiments, the terminal device comprises a circuitry configured to determine a spectrum efficiency associated with the at least one MCS, and wherein the capability information comprises the spectrum efficiency.

In some embodiments, the terminal device comprises a circuitry configured to determine a spectrum efficiency associated with the at least one MCS; and determine a fourth index of the spectrum efficiency, and wherein the capability information comprises the fourth index of the spectrum efficiency.

In some embodiments, the terminal device comprises a circuitry configured to receive a downlink transmission from the network device; in accordance with a determination that the terminal device is unable to support the configured MCS, cause a demodulation of the downlink transmission to be skipped; and transmit, to the network device, a non-acknowledgment of the downlink transmission, and wherein a time duration between a last symbol of the downlink transmission and a first symbol of a transmission of the non-acknowledgment is shorter than another time duration related to the demodulation of the downlink transmission.

In some embodiments, the terminal device comprises a circuitry configured to receive downlink control information from the network device, the downlink control information comprises a fifth index, and the fifth index indicates an antenna port with a rank not exceeding a predetermined value.

In some embodiments, the terminal device comprises a circuitry configured to receive downlink control information from the network device, the downlink control information comprises an indication of a configured waveform associated with the configured MCS.

In some embodiments, the terminal device comprises a circuitry configured to receive downlink control information from the network device, the downlink control information comprises a sixth index, and the sixth index indicates an antenna port with a rank not exceeding a predetermined value, and a configured waveform.

In some embodiments, the terminal device comprises a circuitry configured to receive downlink control information from the network device, the downlink control information indicates a configured PTRS pattern associated with the configured MCS.

In some embodiments, the configured PTRS pattern comprises one of: the PTRS mapped evenly along the scheduled bandwidth based on a distributed pattern, the PTRS mapped at a middle part of a scheduled bandwidth based on a localized pattern, the PTRS mapped at an edge of the scheduled bandwidth based on a localized pattern, or the PTRS mapped at two edges of the scheduled bandwidth based on a localized pattern.

In some embodiments, the configured PTRS pattern further comprises: one non-zero power resource element and at least one zero power resource elements, and wherein the non-zero power resource element locates at middle or edge of a block for the PTRS, and wherein the block is mapped at multiple consecutive resource elements.

In some embodiments, the terminal device comprises a circuitry configured to determine a PTRS pattern based on the configured MCS and the at least one MCS supported by the terminal device.

In some embodiments, a network device comprises a circuitry configured to receive, from a terminal device, capability information indicating: at least one modulation and coding scheme (MCS) supported by the terminal device and at least one configuration associated with the at least one MCS, wherein the at least one configuration comprises a set of parameters associated with the at least one MCS; and transmit, to the terminal device, a configuration of a configured MCS, wherein the configured MCS is not higher than the at least one MCS supported by the terminal device.

In some embodiments, the set of parameters at least comprises: a carrier frequency, a subcarrier spacing, and a waveform.

In some embodiments, the set of parameters further comprises at least one of: a phase tracking reference signal pattern (PTRS) for the at least one MCS, a rank of the at least one MCS, or a phase estimation algorithm.

In some embodiments, the capability information comprises an index of the at least one MCS.

In some embodiments, the at least one MCS comprises a first MCS and a second MCS, and the capability information comprises: a first index of the first MCS and an offset of a second index of the second MCS to the first index of the first MCS.

In some embodiments, the capability information comprises a third index of the at least one configuration, a relationship between the third index and the at least one configuration is predefined.

In some embodiments, the capability information comprises a spectrum efficiency associated with the at least one MCS.

In some embodiments, the capability information comprises a fourth index of a spectrum efficiency associated with the at least one MCS.

In some embodiments, the network device comprises the circuitry configured to transmit downlink control information from the network device, the downlink control information comprises a fifth index, and the fifth index indicates an antenna port with a rank not exceeding a predetermined value.

In some embodiments, the network device comprises the circuitry configured to transmit downlink control information from the network device, the downlink control information comprises an indication of a configured waveform associated with the configured MCS.

In some embodiments, the network device comprises the circuitry configured to transmit downlink control information from the network device, the downlink control information comprises a sixth index, and the sixth index indicates an antenna port with a rank not exceeding a predetermined value, and a configured waveform.

In some embodiments, the network device comprises the circuitry configured to transmit downlink control information from the network device, the downlink control information indicates a configured PTRS pattern associated with the configured MCS.

In some embodiments, the configured PTRS pattern comprises one of: the PTRS mapped evenly along the scheduled bandwidth based on a localized pattern, the PTRS mapped at a middle part of a scheduled bandwidth based on a localized pattern, the PTRS mapped at an edge of the scheduled bandwidth based on a localized pattern, or the PTRS mapped at two edges of the scheduled bandwidth based on a localized pattern.

In some embodiments, the configured PTRS pattern further comprises: one non-zero power resource element and at least one zero power resource elements, and wherein the non-zero power resource element locates at middle or edge of a block for the PTRS, and wherein the block is mapped at multiple consecutive resource elements.

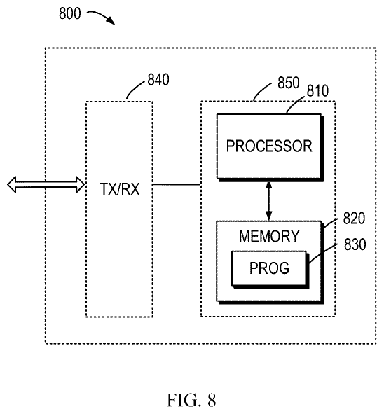

FIG. 8 is a simplified block diagram of a device 800 that is suitable for implementing embodiments of the present disclosure. The device 800 can be considered as a further example implementation of the terminal device 110 as shown in FIG. 1. Accordingly, the device 800 can be implemented at or as at least a part of the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 820 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIG. 2 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1-35. (canceled)

36. A communication method, comprising:
transmitting, at a terminal device and to a network device, capability information indicating: at least one modulation and coding scheme (MCS) supported by the terminal device and at least one configuration associated with the at least one MCS, wherein the at least one configuration comprises a set of parameters associated with the at least one MCS; and
receiving, from the network device, a configuration associated with a configured MCS.

37. The method of claim 36, wherein the set of parameters at least comprises:
a carrier frequency,
a subcarrier spacing, and
a waveform.

38. The method of claim 36, wherein the set of parameters further comprises at least one of:
a phase tracking reference signal (PTRS) pattern for the at least one MCS,
a rank of the at least one MCS, or
a phase estimation algorithm.

39. The method of claim 36, wherein the capability information comprises an index of the at least one MCS.

40. The method of claim 36 wherein the at least one MCS comprises a first MCS and a second MCS, and
wherein the capability information comprises: a first index of the first MCS and an offset of a second index of the second MCS to the first index of the first MCS.

41. The method of claim 36, wherein the capability information comprises a third index of the at least one configuration, wherein a relationship between the third index and the at least one configuration is predefined.

42. The method of claim 36, wherein the capability information comprises the spectrum efficiency associated with the at least one MCS.

43. The method of claim 36, wherein the capability information comprises a fourth index of a spectrum efficiency associated with the at least one MCS.

44. The method of claim 36, wherein an index of the configured MCS is not higher than an index of the at least one MCS supported by the terminal device.

45. The method of claim 36, further comprising:
receiving a downlink transmission from the network device;
in accordance with a determination that the terminal device is unable to support the configured MCS, causing a demodulation of the downlink transmission to be skipped; and
transmitting, to the network device, a non-acknowledgment of the downlink transmission, and wherein a time duration between a last symbol of the downlink transmission and a first symbol of a transmission of the non-acknowledgment is shorter than another time duration related to the demodulation of the downlink transmission.

46. The method of claim 36, further comprising:
receiving downlink control information from the network device, wherein the downlink control information comprises a fifth index, and the fifth index indicates an antenna port with a rank not exceeding a predetermined value.

47. The method of claim 36, further comprising:
receiving downlink control information from the network device, wherein the downlink control information comprises an indication of a configured waveform associated with the configured MCS.

48. The method of claim 36, further comprising:
receiving downlink control information from the network device, wherein the downlink control information comprises a sixth index, and the sixth index indicates an antenna port with a rank not exceeding a predetermined value, and a configured waveform.

49. The method of claim 36, further comprising:
receiving downlink control information from the network device, wherein the downlink control information indicates a configured PTRS pattern associated with the configured MCS.

50. The method of claim 49, wherein the configured PTRS pattern comprises one of:
the PTRS mapped evenly along the scheduled bandwidth based on a distributed pattern,
the PTRS mapped at a middle part of a scheduled bandwidth based on a localized pattern,
the PTRS mapped at an edge of the scheduled bandwidth based on a localized pattern, or
the PTRS mapped at two edges of the scheduled bandwidth based on a localized pattern.

51. The method of claim 50, wherein the configured PTRS pattern further comprises: one non-zero power resource element and at least one zero power resource elements, and wherein the non-zero power resource element locates at middle or edge of a block for the PTRS, and wherein the block is mapped at multiple consecutive resource elements.

52. The method of claim 36, further comprising:
determining a PTRS pattern based on the configured MCS and the at least one MCS supported by the terminal device.

53. A communication method, comprising:
receiving, at a network device and from a terminal device, capability information indicating: at least one modulation and coding scheme (MCS) supported by the terminal device and at least one configuration associated with the at least one MCS, wherein the at least one configuration comprises a set of parameters associated with the at least one MCS; and
transmitting, to the terminal device, a configuration associated with a configured MCS.

54. The method of claim 53, wherein the capability information comprises an index of the at least one MCS.

55. A terminal device comprising:
a processor; and
a memory coupled to the processor and storing instructions thereon, the instructions, when executed by the processor, causing the terminal device to perform the method of claim 36.
